(19) United States
(12) Patent Application Publication
(10) Pub. No.: US 2016/0048979 A1
(43) Pub. Date: Feb. 18, 2016

(54) DESKTOP MANAGEMENT METHOD AND ELECTRONIC DEVICE WITH DESKTOP MANAGEMENT FUNCTION

(71) Applicant: Wistron Corporation, New Taipei City (TW)

(72) Inventors: Chengyan Xu, New Taipei City (TW); Cui Wang, New Taipei City (TW)

(21) Appl. No.: 14/522,590

(22) Filed: Oct. 24, 2014

(30) Foreign Application Priority Data
Aug. 14, 2014 (CN) 201410403862.9

(51) Int. Cl. G06T 11/00; G06F 3/0481

(52) U.S. Cl. CPC G06T 11/001; G06F 3/04817

(57) ABSTRACT

A desktop management method is used for managing a plurality of icons in a desktop. The desktop management method includes steps of setting a first counting period; accumulating a first number of used times of each icon during the first counting period; keeping a default color of N icons when the first number of used times of each of the N icons is larger than a predetermined number; thinning a default color of M icons when the first number of used times of each of the M icons is smaller than or equal to the predetermined number and larger than or equal to 1; and converting a default color of Q icons into transparent and displaying Q marks corresponding to the Q icons when the first number of used times of each of the Q icons is equal to 0.

### BACKGROUND OF THE INVENTION

1. Field of the Invention

The invention relates to a desktop management method and, more particularly, to a desktop management method and an electronic device with desktop management function capable of dynamically adjusting a color and/or a size of each icon in a desktop according to a number of used times of each icon.

2. Description of the Prior Art

As technology advances and develops, various electronic devices including a mobile phone, a personal digital assistant, a tablet computer, a notebook computer, a personal computer, and so on are considered a necessity by a lot of people in their daily lives. At present, a user always installs various applications in his/her electronic device, so as to satisfy different user needs. In general, the user always places the icons associated with frequently used applications in the desktop, so as to enhance work efficiency. However, if the user does not arrange the desktop for a long time, the desktop will be filled with various icons and in disorder, such that the mood of the user and the work efficiency may be affected.

### SUMMARY OF THE INVENTION

The invention provides a desktop management method and an electronic device with desktop management function, so as to solve the aforesaid problems.

According to the claimed invention, a desktop management method for managing a plurality of icons in a desktop comprises steps of setting a first counting period; accumulating a first number of used times of each icon during the first counting period; keeping a default color of N icons when the first number of used times of each of the N icons is larger than a predetermined number, wherein N is equal to 0 or a positive integer; thinning a default color of M icons when the first number of used times of each of the M icons is smaller than or equal to the predetermined number and larger than or equal to 1, wherein M is equal to 0 or a positive integer; and converting a default color of Q icons into transparent and displaying Q marks corresponding to the Q icons when the first number of used times of each of the Q icons is equal to 0, wherein Q is equal to 0 or a positive integer, and at least one of N, M and Q is larger than 0.

According to the claimed invention, the desktop management method further comprises steps of keeping a default size of the N icons; reducing a default size of the M icons to a first size; and reducing a default size of the Q icons to a second size, wherein the second size is smaller than the first size.

According to the claimed invention, the desktop management method further comprises step of when a cursor moves over one of the M icons and the Q icons, displaying the icon by the default color and the default size.

According to the claimed invention, the desktop management method further comprises steps of setting a second counting period; dividing each day into a plurality of time spans during the second counting period; accumulating a second number of used times of each icon during each of the time spans; and displaying one of the icons having a maximum second number of used times by a special effect during each of the time spans.

According to the claimed invention, the desktop management method further comprises step of arranging the N icons, the M icons and the Q icons by a predetermined manner in the desktop in order.

In one example, the predetermined manner is set from an upper left corner to a lower right corner in the desktop or from an upper right corner to a lower left corner in the desktop.

According to the claimed invention, the desktop management method further comprises steps of setting at least one sticky icon from the icons; and keeping displaying the at least one sticky icon at a fixed position in the desktop.

According to the claimed invention, the desktop management method further comprises steps of displaying a setting interface; and setting the first counting period, the second counting period and the at least one sticky icon in the setting interface.

According to the claimed invention, an electronic device with desktop management function comprises a display unit, an input unit, a first counting unit and a processing unit, wherein the processing unit is electrically connected to the display unit, the input unit and the first counting unit. The display unit is sued for displaying a desktop, wherein a plurality of icons is in the desktop. The input unit is used for setting a first counting period. The first counting unit is used for accumulating a first number of used times of each icon during the first counting period. The processing unit keeps a default color of N icons when the first number of used times of each of the N icons is larger than a predetermined number, the processing unit thins a default color of M icons when the first number of used times of each of the M icons is smaller than or equal to the predetermined number and larger than or equal to 1, and the processing unit converts a default color of Q icons into transparent and displaying Q marks corresponding to the Q icons when the first number of used times of each of the Q icons is equal to 0, wherein N is equal to 0 or a positive integer, M is equal to 0 or a positive integer, Q is equal to 0 or a positive integer, and at least one of N, M and Q is larger than 0.

According to the claimed invention, the processing unit keeps a default size of the N icons, reduces a default size of the M icons to a first size and reduces a default size of the Q icons to a second size, the second size is smaller than the first size.

According to the claimed invention, when a cursor moves over one of the M icons and the Q icons, the processing unit displays the icon by the default color and the default size.

According to the claimed invention, the electronic device further comprises a second counting unit electrically connected to the processing unit. The input unit is used for setting a second counting period. The processing unit divides each day into a plurality of time spans during the second counting period. The second counting unit is used for accumulating a second number of used times of each icon during each of the time spans. The processing unit displays one of the icons having a maximum second number of used times by a special effect during each of the time spans.

According to the claimed invention, the processing unit arranges the N icons, the M icons and the Q icons by a predetermined manner in the desktop in order.

In one example, the predetermined manner is set from an upper left corner to a lower right corner in the desktop or from an upper right corner to a lower left corner in the desktop.

According to the claimed invention, the input unit is used for setting at least one sticky icon from the icons, and the processing unit keeps displaying the at least one sticky icon at a fixed position in the desktop.

According to the claimed invention, the display unit displays a setting interface, and the input unit is used for setting the first counting period, the second counting period and the at least one sticky icon in the setting interface.

As mentioned in the above, the invention is capable of dynamically adjusting the color and/or the size of each icon in the desktop according to the number of used times of each icon and arranging the icons by the predetermined manner (e.g. from the upper left corner to the lower right corner or from the upper right corner to the lower left corner) in the desktop in order according to the number of used times of each icon, such that various icons can be well arranged and have gradation in the desktop. Accordingly, a user can find the frequently used icons in the desktop easily according to the variation of the color and/or the size of each icon and can further remove or manage the non-frequently used icons. Furthermore, the invention may display the most frequently used icon by the special effect (e.g. enlarge the size of the icon, increase a light halo to the icon, twinkle the icon, etc.) during each time span, such that the user can execute the icon rapidly in different time spans correspondingly, so as to enhance the work efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating an electronic device with desktop management function according to an embodiment of the invention.

FIG. 2 is a schematic diagram illustrating a desktop displayed by the display unit shown in FIG. 1.

FIG. 3 is a schematic diagram illustrating a setting interface displayed by the display unit shown in FIG. 1.

FIG. 4 is a flowchart illustrating a desktop management method according to an embodiment of the invention.

FIG. 5 is another schematic diagram illustrating the desktop displayed in the display unit shown in FIG. 1.

FIG. 6 is another schematic diagram illustrating the desktop displayed by the display unit shown in FIG. 1.

FIG. 7 is a flowchart illustrating a desktop management method according to another embodiment of the invention.

FIG. 8 is another schematic diagram illustrating the desktop displayed by the display unit shown in FIG. 1.

### DETAILED DESCRIPTION

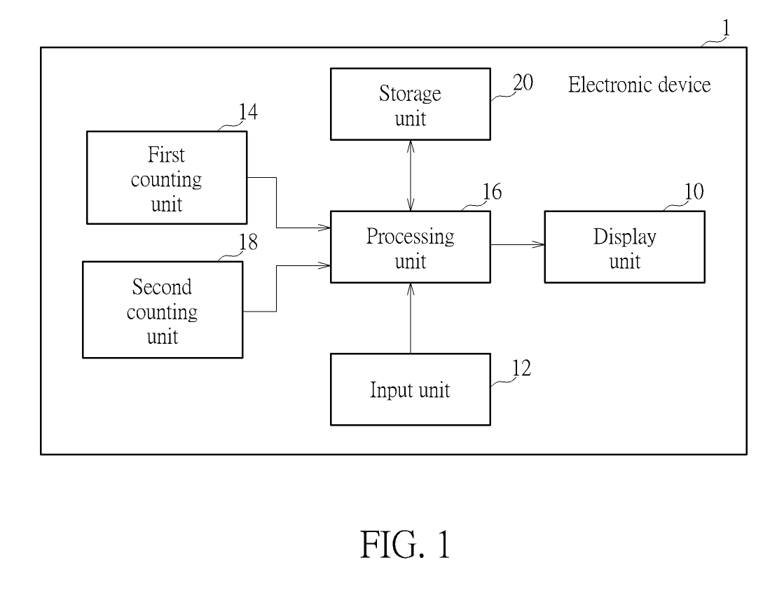

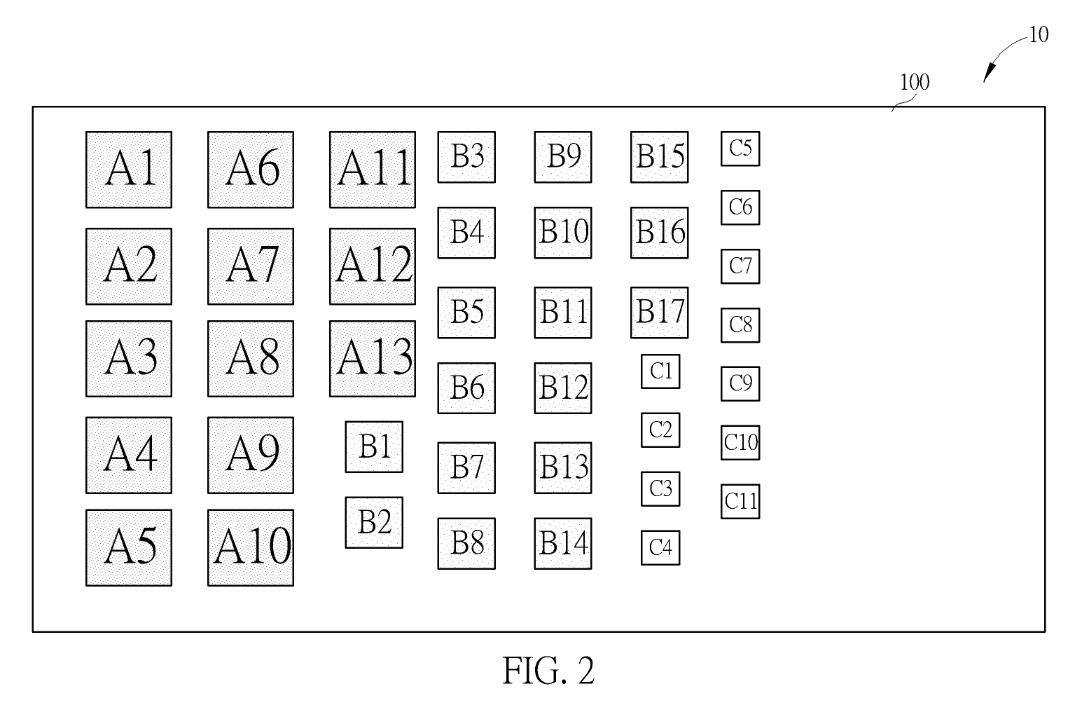

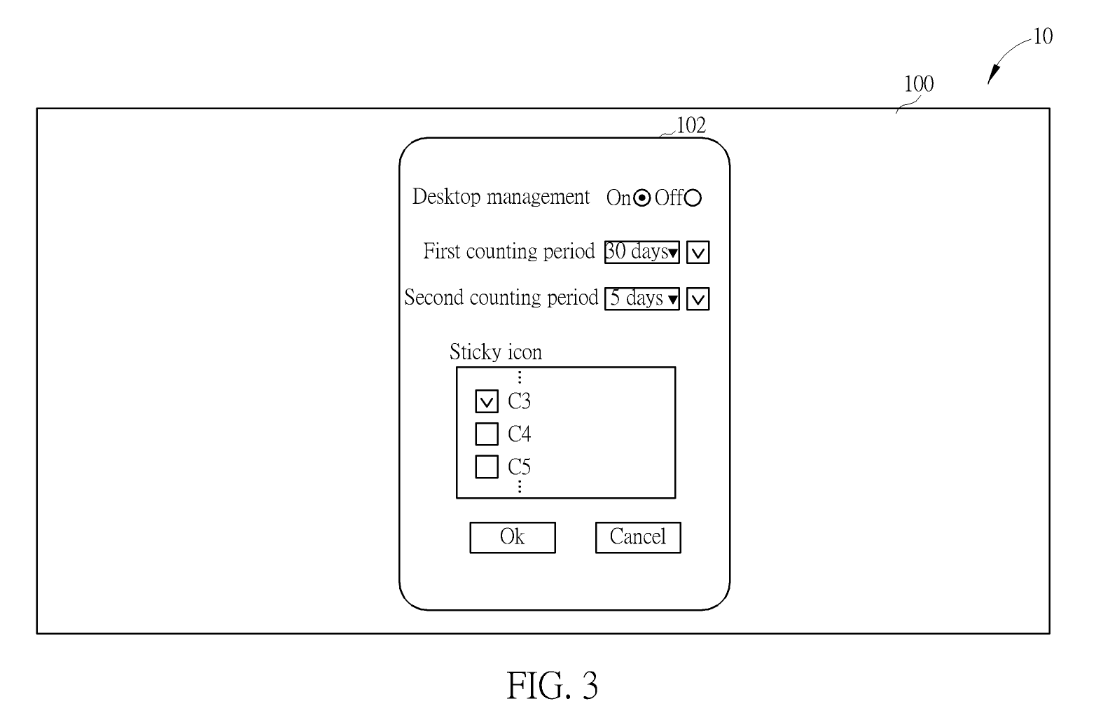

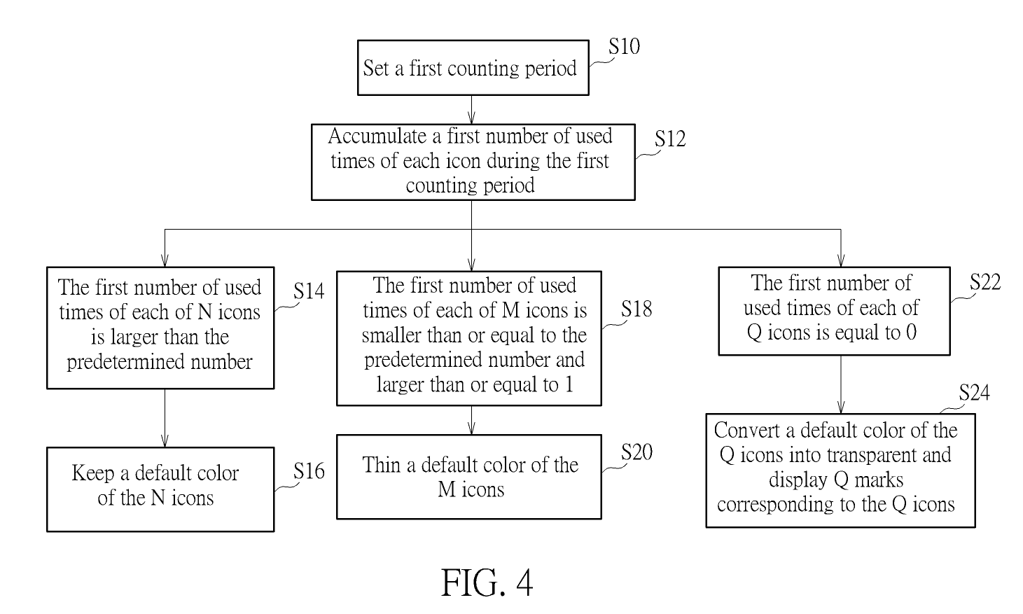

Referring to FIGS. 1 to 4, FIG. 1 is a functional block diagram illustrating an electronic device 1 with desktop management function according to an embodiment of the invention, FIG. 2 is a schematic diagram illustrating a desktop 100 displayed by the display unit 10 shown in FIG. 1, FIG. 3 is a schematic diagram illustrating a setting interface 102 displayed by the display unit 10 shown in FIG. 1, and FIG. 4 is a flowchart illustrating a desktop management method according to an embodiment of the invention. The desktop management method shown in FIG. 4 can be implemented by the electronic device 1 shown in FIG. 1.

As shown in FIG. 1, the electronic device 1 comprises a display unit 10, an input unit 12, a first counting unit 14, a processing unit 16, a second counting unit 18 and a storage unit 20, wherein the processing unit 16 is electrically connected to the display unit 10, the input unit 12, the first counting unit 14, the second counting unit 18 and the storage unit 20. In practical applications, the electronic device 1 may be a mobile phone, a personal digital assistant, a tablet computer, a notebook computer, a personal computer or other electronic devices; the display unit 10 may be a liquid crystal display device or other display devices; the input unit 12 may be a touch panel, keyswitches, a mouse or other input devices; the first counting unit 14 and the second counting unit 18 may be counters; the processing unit 16 may be a processor or controller with data calculating/processing function; and the storage unit 20 may be a hard disc, a memory or other data storage devices. In general, the electronic device 1 may be further equipped with some necessary hardware or software components for specific purposes, such as a power supply, an operating system, a communication module, etc., and it depends on practical applications.

The display unit 10 is used for displaying a desktop 100 and a plurality of icons A1-A13, B1-B17, C1-C11 is in the desktop 100, as shown in FIG. 2. In this embodiment, the icons A1-A13, B1-B17, C1-C11 may be associated with different applications, folders or files stored in the storage unit 20. Furthermore, the desktop management method may be implemented by a desktop management program stored in the storage unit 20.

When a user operates the input unit 12 to execute the desktop management program, the display unit 10 may display a setting interface 102, as shown in FIG. 3. Afterward, the user can operate the input unit 12 to set a first counting period in the setting interface 102 (step S10 in FIG. 4). The aforesaid first counting period may be a default value or set by the user. For example, the first counting period may be 30 days, 15 days or other periods. Then, the first counting unit 14 accumulates a first number of used times of each icon A1-A13, B1-B17, C1-C11 during the first counting period (step S12 in FIG. 4).

When the processing unit 16 determines that the first number of used times of each of N icons of the icons A1-A13, B1-B17, C1-C11 is larger than a predetermined number (step S14 in FIG. 4), the processing unit 16 keeps a default color of the N icons (step S16 in FIG. 4). When the processing unit 16 determines that the first number of used times of each of M icons of the icons A1-A13, B1-B17, C1-C11 is smaller than or equal to the predetermined number and larger than or equal to 1 (step S18 in FIG. 4), the processing unit 16 thins a default color of the M icons (step S20 in FIG. 4). When the processing unit 16 determines that the first number of used times of each of Q icons of the icons A1-A13, B1-B17, C1-C11 is equal to 0 (step S22 in FIG. 4), the processing unit 16 converts a default color of the Q icons into transparent and displays Q marks corresponding to the Q icons (step S24 in FIG. 4). In this embodiment, N is equal to 0 or a positive integer, M is equal to 0 or a positive integer, Q is equal to 0 or a positive integer, and at least one of N, M and Q is larger than 0. Furthermore, the aforesaid predetermined number may be a default value or set by the user. For example, the predetermined number may be 15 times, 10 times or other values.

As shown in FIG. 2, when the processing unit 16 determines that the first number of used times of each of the 13 icons A1-A13 is larger than the predetermined number (i.e. the 13 icons A1-A13 are frequently used during the first counting period), the processing unit 16 keeps the default color of the 13 icons A1-A13 (i.e. the default color of the 13 icons A1-A13 are not changed); when the processing unit 16 determines that the first number of used times of each of the 17 icons B1-B17 is smaller than or equal to the predetermined number and larger than or equal to 1 (i.e. the 17 icons B1-B17 are not frequently used during the first counting period), the processing unit 16 thins the default color of the 17 icons B1-B17 (e.g. the 17 icons B1-B17 may be converted into translucent); and when the processing unit 16 determines that the first number of used times of each of the 11 icons C1-C11 is equal to 0 (i.e. the 11 icons C1-C11 all are not used during the first counting period), the processing unit 16 converts the default color of the 11 icons C1-C11 into transparent and displays 11 marks corresponding to the 11 icons C1-C11 (e.g. only the outside frames of the 11 icons C1-C11 are displayed). The aforesaid marks are not limited to the outside frames of the icons and may be other patterns or symbols.

Accordingly, the user can find the frequently used icons A1-A13 in the desktop 100 easily according to the variation of the color of each icon and can further remove or manage the non-frequently used icons B1-B17, C1-C11.

Moreover, when the processing unit 16 determines that the first number of used times of each of the 13 icons A1-A13 is larger than the predetermined number in step S14, the processing unit 16 may keep a default size of the 13 icons A1-A13 in step S16; when the processing unit 16 determines that the first number of used times of each of the 17 icons B1-B17 is smaller than or equal to the predetermined number and larger than or equal to 1 in step S18, the processing unit 16 may further reduce a default size of the 17 icons B1-B17 to a first size in step S20; and when the processing unit 16 determines that the first number of used times of each of the 11 icons C1-C11 is equal to 0 in step S22, the processing unit 16 may further reduce a default size of the 11 icons C1-C11 to a second size in step S24, wherein the second size is smaller than the first size. For example, the first size may be, but not limited to, one half of the default size and the second size may be, but not limited to, one third of the default size.

Accordingly, the user can find the frequently used icons A1-A13 in the desktop 100 easily according to the variation of the color and/or the size of each icon and can further remove or manage the non-frequently used icons B1-B17, C1-C11. Furthermore, since the sizes of the icons B1-B17, C1-C11 are reduced, the desktop 100 may contain more other icons. Still further, the processing unit 16 may further arrange the 13 icons A1-A13, which are frequently used, the 17 icons B1-B17, which are not frequently used, and the 11 icons C1-C11, which are not used, by a predetermined manner in the desktop 100 in order, such that various icons A1-A13, B1-B17, C1-C11 can be well arranged and have gradation in the desktop 100. For example, the predetermined manner may be set from an upper left corner to a lower right corner in the desktop 100 or from an upper right corner to a lower left corner in the desktop 100. As shown in FIG. 2, the processing unit 16 may arrange the 13 icons A1-A13, which are frequently used, the 17 icons B1-B17, which are not frequently used, and the 11 icons C1-C11, which are not used, from the upper left corner to the lower right corner in the desktop 100 in order.

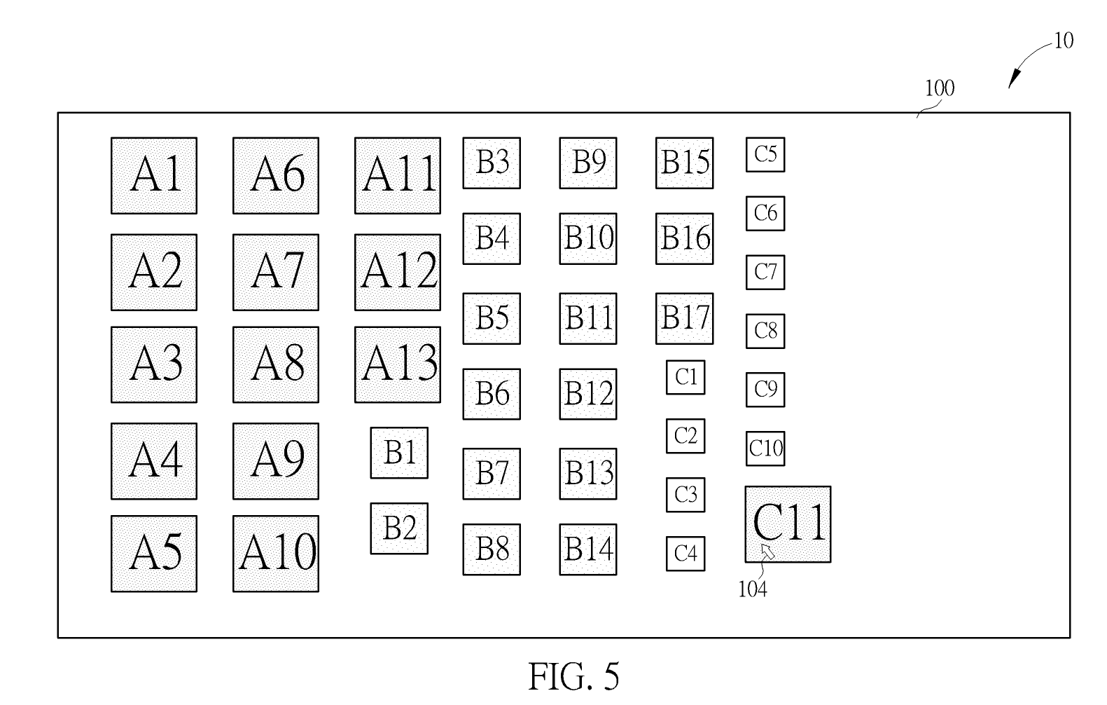

Referring to FIG. 5, FIG. 5 is another schematic diagram illustrating the desktop 100 displayed in the display unit 10 shown in FIG. 1. In this embodiment, when the user moves a cursor 104 over one of the M icons, which are not frequently used, and the Q icons, which are not used, the processing unit 16 may display the icon by the default color and the default size, such that the user can see the icon clearly. As shown in FIG. 5, since the cursor 104 moves over the icon C11, the icon C11 is displayed by the default color and the default size. It should be noted that when the user moves the cursor 104 over any one of the icons A1-A13, B1-B17, C1-C11, the processing unit 16 may also display the icon in high brightness. However, the invention is not limited to the aforesaid embodiment.

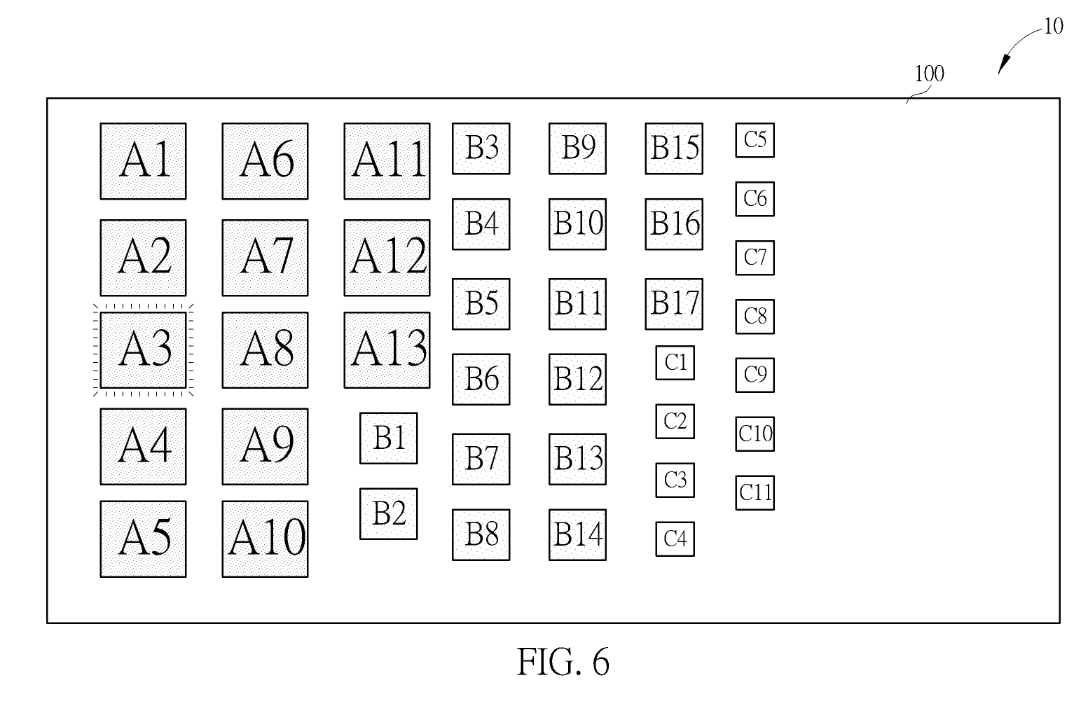

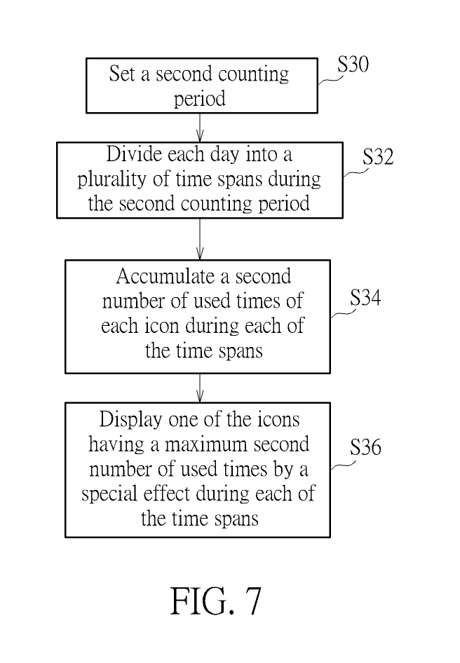

Referring to FIGS. 6 and 7, FIG. 6 is another schematic diagram illustrating the desktop 100 displayed by the display unit 10 shown in FIG. 1, and FIG. 7 is a flowchart illustrating a desktop management method according to another embodiment of the invention. The desktop management method shown in FIG. 7 can be implemented by the electronic device 1 shown in FIG. 1. In this embodiment, the user may further operate the input unit 12 to set a second counting period in the setting interface 102 (step S30 in FIG. 7). The aforesaid second counting period may be a default value or set by the user. For example, the second counting period may be 5 days, 3 days or other periods. Afterward, the processing unit 16 divides each day into a plurality of time spans during the second counting period (step S32 in FIG. 7). For example, the processing unit 16 may take one hour to be one unit to divide each day into 24 time spans or take two hours to be one unit to divide each day into 12 time spans, and it depends on practical applications. Then, the second counting unit 18 accumulates a second number of used times of each icon A1-A13, B1-B17, C1-C11 during each of the time spans (step S34 in FIG. 7). Finally, the processing unit 16 displays one of the icons having the maximum second number of used times by a special effect during each of the time spans (step S36 in FIG. 7).

As shown in FIG. 6, if the second number of used times of the icon A3 is the maximum during 10-11 a.m. every day, the processing unit 16 may display the icon A3 by a light halo (i.e. the aforesaid special effect) during 10-11 a.m., such that the user can find and execute the icon A3 rapidly during 10-11 a.m., so as to enhance the work efficiency. The aforesaid special effect is not limited to the light halo and may be an enlarged size, twinkle or other visual effects. Furthermore, the invention may move the icon with the special effect to a central position of the desktop 100, such that the user may notice the icon more easily.

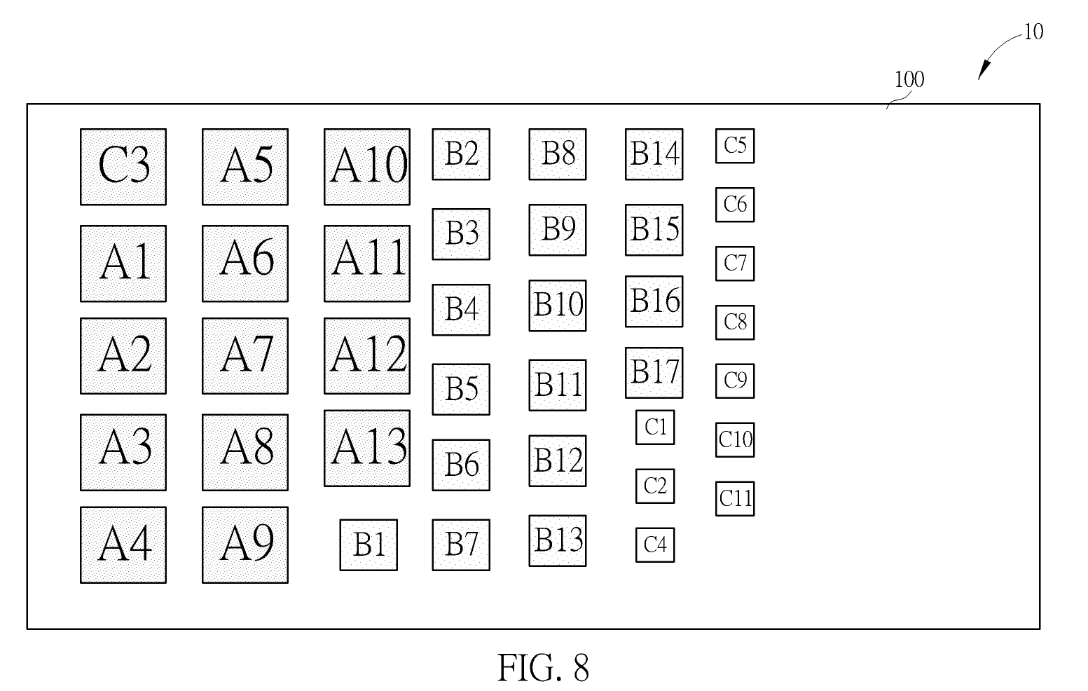

Referring to FIG. 8, FIG. 8 is another schematic diagram illustrating the desktop 100 displayed by the display unit 10 shown in FIG. 1. In this embodiment, the user may further operate the input unit 12 to set at least one sticky icon from the icons A1-A13, B1-B17, C1-C11 in the setting interface 102. At this time, the processing unit 16 will keep displaying the at least one sticky icon at a fixed position in the desktop 100 no matter how many the first number of used times and the second number of used times of the at least one sticky icon are. As shown in FIG. 8, if the user set the icon C3 to be the sticky icon, the icon C3 will be displayed at the upper left corner of the desktop 100 by the default color and the default size. In other words, even though the sticky icon are not frequently used or not used, the invention will not adjust the color and/or the size of the sticky icon. When the user wants to use the icon C3, the user can find the icon C3 in the desktop 100 rapidly. The aforesaid fixed position is not limited to the upper left corner of the desktop 100 and it may be any positions in the desktop 100 set by the user.

It should be noted that the control logic of the desktop management method shown in FIGS. 4 and 7 can be implemented by software. Needless to say, each part or function of the control logic may be implemented by software, hardware or the combination thereof. Moreover, the control logic of the desktop management method shown in FIGS. 4 and 7 can be embodied by a computer readable storage medium, wherein the computer readable storage medium stores instructions, which can be executed by the electronic device so as to generate control command for executing corresponding function.

As mentioned in the above, the invention is capable of dynamically adjusting the color and/or the size of each icon in the desktop according to the number of used times of each icon and arranging the icons by the predetermined manner (e.g. from the upper left corner to the lower right corner or from the upper right corner to the lower left corner) in the desktop in order according to the number of used times of each icon, such that various icons can be well arranged and have gradation in the desktop. Accordingly, a user can find the frequently used icons in the desktop easily according to the variation of the color and/or the size of each icon and can further remove or manage the non-frequently used icons. Furthermore, the invention may display the most frequently used icon by the special effect (e.g. enlarge the size of the icon, increase a light halo to the icon, twinkle the icon, etc.) during each time span, such that the user can execute the icon rapidly in different time spans correspondingly, so as to enhance the work efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A desktop management method for managing a plurality of icons in a desktop comprising:
setting a first counting period;
accumulating a first number of used times of each icon during the first counting period;
keeping a default color of N icons when the first number of used times of each of the N icons is larger than a predetermined number, wherein N is equal to 0 or a positive integer;
thinning a default color of M icons when the first number of used times of each of the M icons is smaller than or equal to the predetermined number and larger than or equal to 1, wherein M is equal to 0 or a positive integer; and
converting a default color of Q icons into transparent and displaying Q marks corresponding to the Q icons when the first number of used times of each of the Q icons is equal to 0, wherein Q is equal to 0 or a positive integer, and at least one of N, M and Q is larger than 0.

2. The desktop management method of claim 1, further comprising:
keeping a default size of the N icons;
reducing a default size of the M icons to a first size; and
reducing a default size of the Q icons to a second size, wherein the second size is smaller than the first size.

3. The desktop management method of claim 2, further comprising:
when a cursor moves over one of the M icons and the Q icons, displaying the icon by the default color and the default size.

4. The desktop management method of claim 3, further comprising:
setting a second counting period;
dividing each day into a plurality of time spans during the second counting period;
accumulating a second number of used times of each icon during each of the time spans; and
displaying one of the icons having a maximum second number of used times by a special effect during each of the time spans.

5. The desktop management method of claim 4, further comprising:
arranging the N icons, the M icons and the Q icons by a predetermined manner in the desktop in order.

6. The desktop management method of claim 5, wherein the predetermined manner is set from an upper left corner to a lower right corner in the desktop or from an upper right corner to a lower left corner in the desktop.

7. The desktop management method of claim 5, further comprising:
setting at least one sticky icon from the icons; and
keeping displaying the at least one sticky icon at a fixed position in the desktop.

8. The desktop management method of claim 7, further comprising:
displaying a setting interface; and
setting the first counting period, the second counting period and the at least one sticky icon in the setting interface.

9. An electronic device with desktop management function comprising:
a display unit for displaying a desktop, a plurality of icons being in the desktop;
an input unit for setting a first counting period;
a first counting unit for accumulating a first number of used times of each icon during the first counting period; and
a processing unit electrically connected to the display unit, the input unit and the first counting unit, the processing unit keeping a default color of N icons when the first number of used times of each of the N icons is larger than a predetermined number, the processing unit thinning a default color of M icons when the first number of used times of each of the M icons is smaller than or equal to the predetermined number and larger than or equal to 1, the processing unit converting a default color of Q icons into transparent and displaying Q marks corresponding to the Q icons when the first number of used times of each of the Q icons is equal to 0, wherein N is equal to 0 or a positive integer, M is equal to 0 or a positive integer, Q is equal to 0 or a positive integer, and at least one of N, M and Q is larger than 0.

10. The electronic device of claim 9, wherein the processing unit keeps a default size of the N icons, reduces a default size of the M icons to a first size and reduces a default size of the Q icons to a second size, the second size is smaller than the first size.

11. The electronic device of claim 10, wherein when a cursor moves over one of the M icons and the Q icons, the processing unit displays the icon by the default color and the default size.

12. The electronic device of claim 11, further comprising a second counting unit electrically connected to the processing unit, wherein the input unit is used for setting a second counting period, the processing unit divides each day into a plurality of time spans during the second counting period, the second counting unit is used for accumulating a second number of used times of each icon during each of the time spans, and the processing unit displays one of the icons having a maximum second number of used times by a special effect during each of the time spans.

13. The electronic device of claim 12, wherein the processing unit arranges the N icons, the M icons and the Q icons by a predetermined manner in the desktop in order.

14. The electronic device of claim 13, wherein the predetermined manner is set from an upper left corner to a lower right corner in the desktop or from an upper right corner to a lower left corner in the desktop.

15. The electronic device of claim 13, wherein the input unit is used for setting at least one sticky icon from the icons, and the processing unit keeps displaying the at least one sticky icon at a fixed position in the desktop.

16. The electronic device of claim 15, wherein the display unit displays a setting interface, and the input unit is used for setting the first counting period, the second counting period and the at least one sticky icon in the setting interface.
